(19) United States
(12) Patent Application Publication
(10) Pub. No.: US 2017/0017966 A1
(43) Pub. Date: Jan. 19, 2017

(54) unknown

(71) Applicant: VISOTTICA INDUSTRIE S.p.A., Susegana TV (IT)

(72) Inventor: Rinaldo MONTALBAN, Susegana TV (IT)

(21) Appl. No.: 15/212,624

(22) Filed: Jul. 18, 2016

(30) Foreign Application Priority Data
Jul. 16, 2015 (IT) 102015000035120

(51) Int. Cl. G06Q 30/00; G06F 17/30

(52) U.S. Cl. CPC G06Q 30/018; G06F 17/30312

(57) ABSTRACT

A method and system for authenticating products, include: one marker attachable to the product offered for sale; a software application installed on a portable personal device equipped with a sensor for detecting the marker and a channel for transmitting the acquired data to a communications network; a certification database accessible from the network, in which data on the marker and on the product are associated. The marker includes one pair of distinct codes uniquely correlated with one another inside the certification database, a freely accessible primary identification code and a secondary unlocking code that is concealed on the marker and is accessible only by a breakable seal that makes it apparent that it has been accessed. The primary code is uniquely tied in the database to general information on the product, and the secondary unlocking code is uniquely associated with identification data on the user in the database.

### SCOPE OF THE INVENTION

This invention pertains to a method for the authentication and attribution of the ownership of an item of personal property, in particular an item that is easily moved around such as a pair of eyeglasses.

### TECHNICAL BACKGROUND

The market for luxury goods has already developed various authentication systems that make it possible for a buyer or a protection entity (for example, insurance companies) to verify the original nature of the product with which he/she/it is interacting.

These systems have traditionally relied on devices that are relatively expensive because, in addition to the presence of a unique identifier (such as an RFID tag) that is attached to the item that is the subject of the transaction, they also involve special sensing equipment and the corresponding dedicated interfaces that talk to the servers belonging to the certifying entity. In cases where the identifier is simpler (barcodes, magnetic strips, . . . ), the authentication process is normally much more complex, with the burden falling on the user.

Some examples of the prior art are described in WO9855970, US2004044596, and WO03060815.

The advantage of using unique identifiers of the complex type lies in the capability of inputting useful items of information regarding the product with which they are associated, but it makes the process of reading and processing the information more complex and at the same time still relies on the help of professional operators. In other words, these systems are designed to operate only at the last link in the professional distribution chain (i.e., the vendor) but are not available to the individual user/buyer.

Simpler systems are known, though, that are available to the end-users, but their purpose is simply to perform the function of providing generic advertising information regarding the item without, however, offering any way of authenticating the item itself. For example, U.S. Pat. No. 8,261,972 describes methods for “cross-promotion” in which a product is equipped with a two-dimensional code (QR code, MS tag, etc.) that can be read by a smart phone belonging to a potential buyer and that refers to a webpage that contains cross-referenced advertising material linked to the product itself.

US20120085828A1 describes a cross-promotion system that uses a tag that is to be attached/secured to a product and that provides a code (for example, a QR code) that can be read by a device such as a smart phone and that refers to an Internet site that provides advertising or information on the product itself. This serves as a kind of information tag, except that it can be consulted electronically. There is no suggestion of any other use of the code.

There are a number of other systems in which a concealed unique code is attached to a product and is simply designed to verify authenticity.

For example, WO2013108220A1 describes a label that can be affixed to a product and that contains a breakable code (a QR code hidden under a covering coating) of the “one-shot” type). This approach does not provide any other effect or advantage for the buyer. Proof of the authenticity of the item is provided only after the product has been physically acquired and after the coating on the code has been removed.

The applicant has determined, however, that there exists a requirement on the part of the end-users/buyers to be able to manage an authentication process easily and automatically as well as to interact independently with the information associated with the items, even before the purchase transaction takes place, but also to be able to establish a personalized relationship (such as the claim of ownership) with the item outside of the professional distribution chain.

### SUMMARY DESCRIPTION OF THE INVENTION

The purpose of this invention is thus to provide an authentication method in which the elements identifying the product are fairly low in cost and easy to access and in which the user is able to access the authentication system independently with tools available to him, to interact with the product to extract pertinent information, to ascertain its authenticity, and to establish a personalized relationship with the product.

This purpose is achieved by means of the method and system that are described in their essential outlines in the attached principal claim.

Other inventive aspects of the invention are described in the subordinate claims.

### BRIEF DESCRIPTION OF THE FIGURES

Other characteristics and advantages of the device according to the invention will be further explained by the detailed description given below of some preferred embodiments of the invention, which are given by way of example and are illustrated in the attached drawings, where:

FIG. 1 is a schematic view that illustrates how the devices of the system of the invention interact; and

FIG. 2 is a table that shows the method of associating unique codes according to the invention within the database.

### DETAILED DESCRIPTION OF A CURRENTLY PREFERRED EMBODIMENT

In a known way, an authentication system comprises a marker or seal to be affixed (in a removable manner or otherwise) to an item to be sold. The item to be sold may be a pair of eyeglasses, but also a bottle of wine or other quality product, and features many characteristics that can be appreciated in different ways by the clientele.

The seal is affixed at an initial stage of the production process and thus can follow the progress of the item starting at the first phases of exiting the production facility if there is a need to certify its origin (and thus its genuineness or guarantee of compliance).

According to the invention, the marker contains at least one pair of distinct codes:
(i) a primary identification code that is available to the user even when not in possession of the item and that can be read by an electronic device that is readily available to an ordinary user (such as a smart phone, tablet, or other similar device), and
(ii) a secondary unlocking code that can be read even without electronic devices.

The primary identification code typically comes in the form of an NFC tag or QR code, while the secondary unlocking code, in addition to being of the same type as the primary code, can also come in the form of a simple alphanumeric string.

The marker is configured in such a way as to conceal the secondary unlocking code; in order to be able to make the secondary code readable, a breakable seal, for example, a removable strip, a tear-off film, or a scratch-off varnish is provided that makes it clear instantly that the secondary code of this marker has been accessed.

As mentioned, the marker can be affixed to the product in such a way that it is more or less easy to remove; it can also be provided that, for example, the primary identification code is attached to the object while the secondary unlocking code is affixed in a removable way (or vice versa) depending on the type of the product, its size, the materials of which it is made, or the types of the two codes described above.

The marker is produced at a preliminary phase with coordination taking place between a producer or distributor of the good and a certifying entity. The latter maintains, with the appropriate information security guarantees, a computer database in which the associations between the goods/products and the corresponding markers are recorded. The computer database is installed in a communications network so as to be accessible even from a remote location.

In the final phase of the process, as indicated below, the same computer database also records the associations with the references of the user who claims ownership of the good/product.

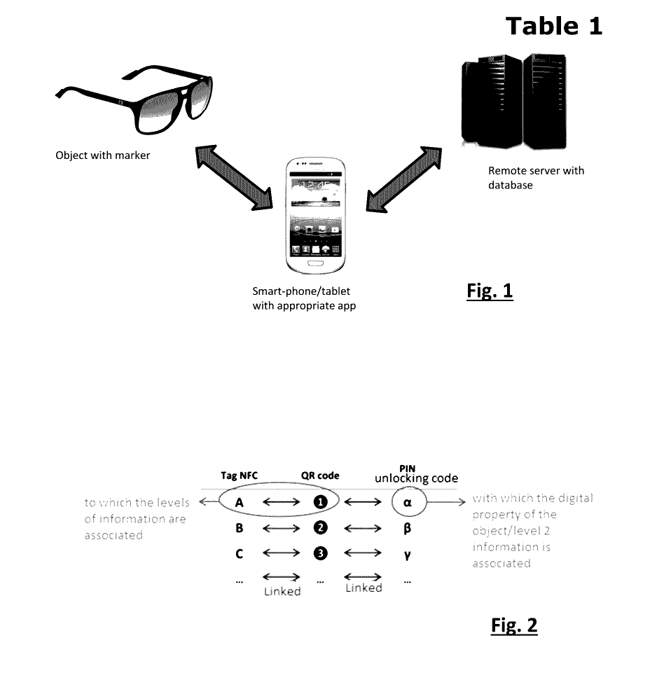

The system is further supplemented by an electronic device available to the user (such as a smart phone or tablet) that has the capability of collecting the data from the marker and transferring it, via an appropriate communications channel (such as Internet data transmission), to the database management server (FIG. 1).

The operating method is based on a series of phases, the main ones of which are described below.

First, at the time when a request is made to activate the service, a sequence of primary and secondary codes is generated for each marker (FIG. 2), with said sequence then being loaded into a database along with the references of the goods/products whose originality is to be certified. A specific good/service that is to be distributed and sold thus becomes associated with each unique marker.

More specifically, at least two primary and secondary codes are thus associated with every good/product offered for sale, where said codes are attached not only to the good/product itself but are also uniquely linked to one another inside the database.

A series of items of information, as shown in FIG. 2, is then linked to or, better stated, associated with these two codes. Thus, a series of generic, technical, or commercial data on the good itself, such as for example a pair of eyeglasses, is associated with each primary code by means of a separate relational database or, advantageously, within the same database. This data can be consulted by means of a specific software application (app) that is made available to the user by the certifying entity and that can be installed on a smart phone or tablet.

The primary identification code is essentially a generic identification code that is visible or at least easily readable on the marker affixed to the product; it allows the user (in any situation, even without having acquired the good) to be directed to a first level of information.

At the same time, the secondary unlocking code constitutes an identification/ownership code. This code is initially hidden from view and is made available by breaking the seal of the marker; it is thus a code that can be used only one time.

Once the marker has been associated with the good, the latter is offered for sale after making its way through the distribution chain. The potential buyer, using the appropriate software application installed on his smart phone or tablet, can easily gain access to the history and the information pertaining to the various goods offered. For example, when the user's smart phone is brought close to the product for sale, it is possible to read the primary code and thus to have automatic access to all of the information that it has been decided to make available by means of the association in the database, for example the layout and originality of the product, commercial information, technical information, etc.

This first level of “a new acquisition experience” is thus freely accessible to everyone and is dependent only on installing the software application.

If the user also decides to buy the good, the true and actual final phase of sale takes place. Once the acquisition transaction is completed, the buyer can access the marker (or at least the part thereof that contains the secondary code) and break the portion of the seal (preferably by physically modifying the seal so as to make it clear that it has been breached) so as to gain access to the secondary unlocking code.

As mentioned, this secondary hidden code is of the “one-shot” type since it can be used only once. This code is acquired via a data input interface (with manual input or via an optical reader) that is present on the software application, along with the primary code and the identification data on the owner, in order to establish a unique and stable association that is forwarded to the remote database; in this way, the good is inseparably associated with its owner by the data residing on the server of the certifying entity.

In essence, with this ownership association (which can be personalized as desired based on the data and the owner's preferences that are input via the acquisition interface), a second level of characteristics and data is unlocked that are not otherwise accessible with just the primary code, for example “digital” attribution of ownership of the good (for example, a pair of eyeglasses), data on the owner (last name, first name, email address, . . . ), personalized guarantee, VIP club code, etc.

In the event that someone accessed and utilized the unlocking code without then actually buying the glasses, it would unavoidably leave a permanent computerized trail on the database of the certification server; thus, in the case of a second client who is later interested in the same product, bringing his own smart phone up to the item and obtaining the first-level information would immediately inform him that these glasses have already been associated with another owner (or that its unlocking code has already been activated).

As mentioned, it is advantageous for the access to the unlocking code to have to occur by “breaking”, even physically, the seal of the marker (for example, as already mentioned above, by removing a strip, stripping away a film, or scratching off a layer of varnish); in this way the customer (or reseller) can immediately determine that the seal on the good has been tampered with.

The process according to the invention, which has two codes on the marker, one of which is hidden and is accessible only by leaving clear tracks, makes it possible to attribute a “digital ownership” to the physical good, by means of which it is possible to establish a personalized association between the good and the user, which also determines an optional delivery of personalized information and services that add value to the user's buying experience.

The service that is being proposed using the method and system of the invention will thus alter the consumer's traditional buying experience. The service in fact calls for three micro-phases:
1. Connection to the product;
2. Acquisition of ownership and the resulting personalized association;
3. Access to reserved areas and a social world that are tailored to the buyer's desires.

With the dedicated software application, it is possible to interrogate the primary code of the electronic seal (marker) using even more than one technology; for example, it is possible to have simultaneously an NFC tag for systems equipped with NFC readers and a QR code for systems that do not have an NFC reader. With these two options (or others that should become widely accessible as technology evolves) all the smart phones on the market will be able to interact with the object. The smart phone itself can, through the application, automatically select the interrogation technology based on the presence or absence of the NFC reader.

Once the reading of the electronic seal has taken place, the system is connected to the remote database in order to access all of the information that has been associated with this primary code thus far. The connection to the database for access to the first-level information associated with the identification number of the seal does the following in particular:
verifies the authenticity of the product;
provides various commercial information (promotional videos, specific information on the product, origin of the product, . . . )
Makes it possible to access the phase of acquisition of digital ownership of the product.

It is important to reiterate that the verification of the authenticity of the product is a verification that comes presold, a characteristic which turns out to be innovative in the context of certification markers.

The ownership acquisition phase happens via the “breaking of the seal” and access to the secret secondary code, to be attributed in the appropriate place in the application. In this way there is an absolute guarantee that fraudulent attribution cannot have taken place without the product or the marker itself having been damaged, which would become apparent to other potential buyers.

An option can provide for the attribution of ownership (or the expenditure of the secondary code that establishes the personalized association) to be done by the business using an add-on business code that makes it faster to attribute, for example, multiple goods simultaneously and or makes the authentication process more reliable and robust.

Once ownership of the product has been acquired, there is access to reserved areas and an optional social network dedicated to this type of good or user. In reserved areas it is possible to gain access to many types of information, such as terms of guarantees, certifications, data on the specific product when a certain extent of it has been assembled (for example, technical data on the ophthalmic lenses of a pair of glasses), etc. In these reserved areas it is also possible to define an interaction between buyer and producer, for example with an interface for evaluating the product (its own specific network or the sales network) or to collect loyalty points, etc.

Finally, it is possible for the customer to organize the objects purchased into a kind of virtual cabinet: through the application it is possible to manage this virtual cabinet and to share this information through the most common social networks.

Thanks to the inventive approach proposed, it is also possible to obtain advantageous feedback on the value added that the user attributes to the good purchased. In particular:

The consumer's buying experience is modified, creating a connection to the good that is simple and intuitive through the use of a smart phone/tablet, a dedicated app, and a marker;

The originality of the product is guaranteed and digital ownership is attributed to it through a robust coding system that is difficult to counterfeit;

A direct relationship is created between the producer and the end buyer, creating new opportunities for offering services and targeted marketing.

It is also intended that the invention not be limited to the particular configurations outlined above, which are only non-limiting examples of the scope of the invention; rather, numerous variants are possible, all within the grasp of one skilled in the art without thereby exceeding the framework of the invention.

1. Product authentication system, comprising
at least one marker that can be attached to a product offered for sale,
a software application installed on a personal portable device that is equipped with at least one detection sensor for said at least one marker and a channel for transmitting the data acquired to a communications network,
a computer certification database that is accessible from the communications network in which at least data pertaining to said marker and data pertaining to said product are associated, where,
said marker comprises at least one pair of distinct codes that are uniquely correlated with one another within said certification database, a freely accessible primary identification code, and a second unlocking code that is hidden on said marker and is accessible only by means of a breakable seal that makes quite apparent the fact that it has been accessed, with this primary code being uniquely connected in said database to general information on said product, and
said secondary unlocking code is uniquely associated with identification information on the user in said certification database so as to associate said product with said user in a personalized manner.

2. System as described in claim 1, in which said primary identification code is in the form of an NFC tag or a QR code.

3. System as described in claim 1, in which said secondary unlocking code comes in the form of a QR code or alphanumeric string.

4. System as described in claim 1, in which the marker comprises a breakable seal that conceals the secondary unlocking code.

5. Product authentication method that uses an authentication system as described in claim 1, in which the following phases are carried out:
at the point when a product is produced or distributed, at least the product is pre-equipped with at least one marker that has at least one pair of distinct codes, a freely accessible primary identification code and a secondary unlocking code that is concealed on said marker and is accessible only by means of a breakable seal that makes apparent the fact that it has been accessed,
said primary and secondary codes are uniquely associated with one another and with corresponding data for identifying the product in a certification database that is accessible from a communications network,
a software application is provided that is installed on a personal portable device that is equipped with at least one detection sensor for said marker and a channel for transmitting data acquired to said communications channel, characterized by the fact that following a purchase action, this software application makes it possible to acquire at least said secondary unlocking code after breaking the breakable seal, along with identification data on the user that are uniquely associated in the certification database so as to associate this product with this user in a personalized manner.
